(19) United States
(12) Patent Application Publication
(10) Pub. No.: US 2019/0073404 A1
(43) Pub. Date: Mar. 7, 2019

(54) INFORMATION RETRIEVAL CONTROL

(71) Applicant: University of Helsinki, Helsingin Yliopisto (FI)

(72) Inventors: Khalil KLOUCHE, Helsingin Yliopisto (FI); Tuukka RUOTSALO, Helsinki (FI); Luana MICALLEF, Espoo (FI); Salvatore ANDOLINA, Helsingin Yliopisto (FI); Giulio JACUCCI, Espoo (FI)

(73) Assignee: University of Helsinki, Helsingin Yliopisto (FI)

(21) Appl. No.: 16/085,174

(22) PCT Filed: Mar. 20, 2017
(86) PCT No.: PCT/FI2017/050187

§ 371 Date: Sep. 14, 2018

(30) Foreign Application Priority Data
Mar. 18, 2016 (FI) 20165225

(51) Int. Cl. G06F 17/30

(52) U.S. Cl. CPC G06F 17/30554; G06F 17/30333; G06F 17/30011; G06F 17/3053

(57) ABSTRACT

Method, computer program and apparatus are disclosed in which search phrases are arranged multi-dimensionally in a relevance map pointing which the user can define weights of the search phrases. Documents are correspondingly ranked based on the weights and a result list is formed and presented accordingly.

The aspects of the disclosed embodiments generally relate to information retrieval control.

### BACKGROUND ART

This section illustrates useful background information without admission of any technique described herein representative of the state of the art.

Mankind has developed with ever increasing pace thanks to developments in the technology in information distribution. Guttenberg brought printed books available to new social groups, with ultimate revolutionary effect in educating nations by large. The Internet, on the other hand, has made publication practically free and simultaneously available all over the world. Publication and distribution are no longer bottlenecks in sharing information. Instead, the major challenge is often the finding of desired material from the vast and ever increasing bulk of publications.

There are various free search engines that cleverly employ metadata of Internet publications. For example, web pages linked that are linked to by many other web pages are typically more interesting as well as web pages that are visited more often or the IP address of which is more often queried from domain name servers. However, regardless of how the search is conducted, in the end the user is normally provided with a list of hits.

A hit list typically shows an excerpt of the found publication alongside with its uniform resource locator (URL). Sometimes, desired information is found from the first place of the hit list. However, this is not always the case. It is often a tedious task to browse through such lists and sometimes peek at the pages of the URL's only to find that the hit list was slightly off and the search phrase has to be modified.

In order to modify the search phrase, the user may use particular Boolean definitions such as flag some words or phrase to be found in their literal form or require the presence of some words or define the time of the publication or use other metadata. This search process is the more frustrating the slower the review of the search hits is and the more the search is actually off its actual target. Poor focusing of search is particularly difficult on searching for unfamiliar information or when the search involves key words that are extremely ubiquitous, such as on searching for information relating to ubiquitous Internet technologies.

It is an object of the aspects of the disclosed embodiments to improve information retrieval control or at least provide a new technique for this purpose.

### SUMMARY

According to a first aspect of the present disclosure there is provided a method comprising:
a) organizing multi-dimensionally a plurality of search results obtained with a plurality of search phrases;
b) presenting to a user the plurality of search phrases multi-dimensionally in a relevance map, each search phrase corresponding to one dimension of the relevance map;
c) identifying a point on the relevance map that is pointed by the user;
d) defining weights of the search phrases according to the point on the relevance map;
e) ranking documents based on the weights and based on the ranking forming a result list that identifies a plurality of the documents as search results;
f) presenting the result list; and
g) returning to step c).

The search phrases may be defined by the user. The search phrases may comprise keywords. The search phrases may comprise a metadata criterion. The metadata may comprise any of temporal data; geographical data; type of document; size of document; author information; and publication information.

The presenting of the result list may comprise displaying a listing of at least a sub-set of the search results. Additionally or alternatively, the presenting of the result list may comprise presenting to the user search result markers. The search result markers may be presented multi-dimensionally on the relevance map search result markers corresponding to at least a sub-set of the search results.

The search result markers may indicate that how relevant said search results are for each of the search phrases. The presenting of the search result markers may comprise indicating total relevancies of respective search results with respect to all the search phrases. The indicating of the total relevancies may comprise adjusting appearance of the search result markers based on their total relevancies. The adjusting of the appearance may comprise adjusting any one or more of: color; size; brightness; shape; fill pattern; and blinking.

The search result markers may be displayed as partly transparent. The user may be enabled to perceive plural search result markers even if partly or entirely overlaid.

The method may comprise providing the user with different suggestions for new search phrases specifically to different points on the map. The method may comprise providing the user with a suggestion for a new search phrase on moving a cursor or hovering a touching object next to a touch display. The touching object may be any of: a stylus; a finger; a palm; a hand; and a pen. The method may comprise adding a new search phrase by the user selecting a presented suggestion.

The method may comprise providing the user with an option to delete a search phrase. A desire of the user to delete a search phrase may be detected by prompting the user whether the search phrase should be deleted if the user points at the search phrase.

The method may comprise changing the search phrases. The method may further or alternatively comprise changing alignment of the search phrases. After changing any of the search phrases or the alignment of the search phrases, the method may comprise returning to step a).

The relevance map may comprise ambiguous areas. The method may comprise rearranging the relevance map to resolve ambiguity. The method may comprise presenting two or more different instances of the relevance maps with different the alignment of the dimensions in which greatest distances between their dimension maxima appear for different search phrases. The method may comprise temporarily disabling one or more of the search phrases to permit a temporary focus on remaining search phrases. A disabled search phrase may be indicated by changing appearance of its indication in the relevance map. The method may comprise changing the orientation of dimensions of the relevance map presentation under user control. The user control may comprise dragging a search phrase indication that identifies an end of a respective dimension on the presentation of the relevance map. The search phrase indication may comprise a query marker. The query marker may comprise any of a symbol; a search phrase as text; and an extract or abbreviation of the search phrase.

The method may comprise presenting a dynamic list of search results based on a position of interest indicated by the user on the relevance map. The position of interest may be indicated by hovering a touching object onto the position of interest or by moving an exploration cursor onto the position of interest. The search result markers that correspond to the search results being presented in the dynamic list may be highlighted in the relevance map to be user perceivably distinguishable from other search result markers. The method may comprise allowing the user to scroll the dynamic list. The method may comprise updating the highlighting of the search result markers that correspond to the search results being presented in the dynamic list so that the search result markers are highlighted for those search results that are visible in the scrolled dynamic list.

Advantageously, a user may be shown search result markers for search results in a coordinate map so that the relevance of the search results is visible with respect to plural search phrases. Advantageously, the user may be allowed to adjust the search by redefining the weighting of the search phrases by simply indicating a desired user selected position of the coordinate map.

The search phrases may be extracted from the result list or form the document collection. The search phrases may be input from the user. The search phrases may be input with a text input box. The text input box may be provided to the user before performing a first search. The input box may be provided to the user after performing a first search. The input box may be populated by the content of a search phrase on pointing a respective query marker.

The method may comprise visualizing search result markers that appear in the result list. Search result markers may be visualized with a user perceivable appearance in the coordinate map if they appear in the result list. The user perceivable appearance may be provided by a particular color, highlight, box, pattern, blinking or other visual marking or effect.

Visited areas and non-visited areas of the relevance map may be visually distinguished. The visual distinguishing may employ a given user perceivable appearance in the coordinate map. The user perceivable appearance may be provided by a particular color, highlight, box, pattern, blinking or other visual marking or effect.

The method may comprise allowing the user to change the scale at which the relevance map is displayed. The changing of scale may be performed using a mouse scroll, or a pinch or zoom gesture on touch display, by tapping or double tapping a touch display and/or by a keyboard command.

The method may comprise automatic arrangement of the relevance map upon creation of a new search phrase and/or removal of an existing search phrase. The automatic arrangement of the relevance map may comprise displaying an updated set of search phrases.

The search phrases may be shown in a circular configuration.

The user may be able to distinguish between visited and non-visited areas of the relevance map according to the coloration of the search result markers.

The method may comprise providing the user with an option to change the scale at which the relevance map is displayed. Such an option may be performed using a mouse scroll, or a pinch/zoom gesture on touch display.

According to a second aspect of the present disclosure there is provided a method comprising performing interactive information retrieval in subsequent loops comprising:

obtaining, corresponding to a plurality of search phrases and corresponding weights, a first set of search results and a relevance ranking for each of the search results of the first set with respect to each of the search phrases;

associating each of the search phrases with a respective coordinate axis;

computing mutual position for each of the search results of the first set based on the relevance rankings;

causing displaying in a coordinate map:
a search result marker for each of the search results of the first set at a position based on the respective computed mutual position; and
an indication of an coordinate axis for each of the search phrases; and;

receiving an indication of a user selected position of the coordinate map;

and in response to the receiving of the indication:
updating weights for each of the search phrases based on the selected position with respect to the respective coordinate axis; and
repeating the loop.

The method may comprise obtaining a second set of search results in addition to the first set of search results. On updating the weights and repeating the process, the first set of search results may comprise a modified previously obtained first set of search results. The first set of search results may be modified by at least one of: rejecting one or more search results from the previously obtained first set of search results; adding one or more search results of the previously obtained second set of search results to the previously obtained first set of search results; and adding one or more search results that are new over those of the previously obtained first and second set.

Advantageously, a search may be performed for information retrieval with given search phrases and weighting of the search phrases and then the weights may be updated and the earlier search results may be rearranged based on the updated weights. Hence, the group of search result markers displayed to the user may be refined without necessarily conducting a new search. In an alternative embodiment where new search results are included in the new first set, the search result markers may be updated using new search results. The previous first set may be if not all of the search results of the previously obtained first set of search results are rejected.

According to a third aspect of the present disclosure there is provided a method in which search phrases are arranged multi-dimensionally in a relevance map pointing which the user can define weights of the search phrases. Documents are correspondingly ranked based on the weights and a result list is formed and presented accordingly.

According to a fourth aspect of the present disclosure there is provided computer program comprising computer executable program code which when executed by at least one processor causes an apparatus to perform the method of any of the first to third aspect.

According to a fifth aspect of the present disclosure there is provided a computer program product comprising a non-transitory computer readable medium having the computer program of the fourth aspect stored thereon.

According to a sixth aspect of the present disclosuer there is provided an apparatus comprising:

a memory for storing information;

a data interface for causing presenting information to a user and receiving information from the user; and

a processor for controlling operation of the apparatus;

wherein the processor is configured to cause the apparatus to perform the method of any of the first and second aspect.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding aspects and embodiments of the present disclosure have been illustrated in the foregoing. The embodiments in the foregoing are used merely to explain selected aspects or steps that may be utilized in implementations of the present disclosure. Some embodiments may be presented only with reference to certain aspects of the present disclosure. It should be appreciated that corresponding embodiments may apply to other aspects as well.

### BRIEF DESCRIPTION OF THE DRAWINGS

Some embodiments of the present disclosure will be described with reference to the accompanying drawings as non-limiting examples, in which:

FIG. 1 shows a schematic picture of a system according to an embodiment of the present disclosure;

FIG. 2 shows a flow chart illustrating a method of an embodiment of the present disclosure;

FIG. 3 shows an example of a relevance map of an embodiment of the present disclosure;

FIGS. 4A to 4C show further details of the relevance map of FIG. 3;

FIG. 4 shows main signaling according to an embodiment of the present disclosure;

FIG. 5 shows main signaling according to another embodiment of the present disclosure;

FIGS. 6, 7, 8A and 8B show example visualizations;

FIGS. 9 to 12 show results of a performance experiment; and

FIGS. 13 and 14 show results regarding interaction behavior.

### DETAILED DESCRIPTION

In the following description, like reference signs denote like elements or steps.

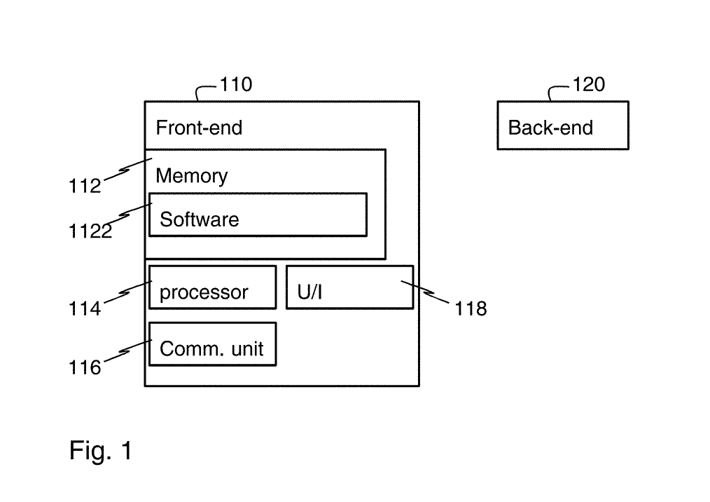

FIG. 1 shows a schematic picture of a system 100 according to an embodiment of the invention. The system comprises a front-end 110 such as a laptop computer, tablet computer, mobile phone or dumb terminal for accessing remote computing resource. The system 100 further comprises a back-end or search engine 120.

The front-end 110 comprises a memory 112 that comprises computer program code 1122; a processor 114; and a communication unit 116. The communication unit comprises, for example, any of a networking circuitry (such as local area networking or wide area networking circuitry); peripheral communication circuitry such as a universal serial bus (USB) circuitry; and Bluetooth communication circuitry. The front-end 110 may further comprise a user interface 118 that comprises, for example, any of a display; keyboard; pointing device; camera; 3D display; gesture recognition device; speech recognition device; and/or speech synthesis device.

In some embodiments, the back-end and front end are commonly provided by same equipment.

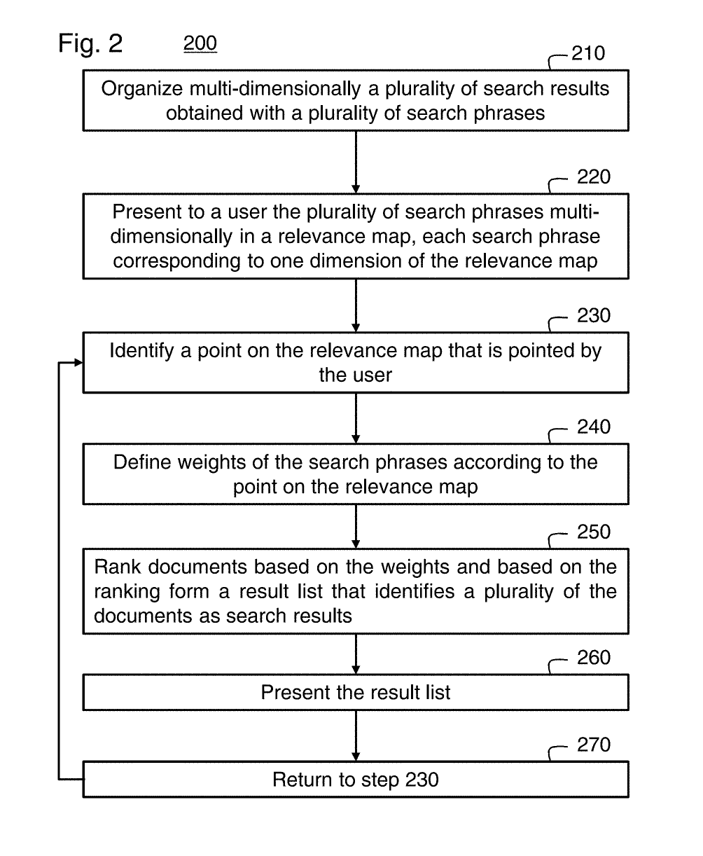

FIG. 2 shows a flow chart illustrating a method 200 of an embodiment of the present disclosure. The method 200 comprises:

210. organizing multi-dimensionally a plurality of search results obtained with a plurality of search phrases;
220. presenting to a user the plurality of search phrases multi-dimensionally in a relevance map, each search phrase corresponding to one dimension of the relevance map;
230. identifying a point on the relevance map that is pointed by the user;
240. defining weights of the search phrases according to the point on the relevance map;
250. ranking documents based on the weights and based on the ranking forming a result list that identifies a plurality of the documents as search results;
260. presenting the result list; and
270. returning to step 230.

The search results are presented in an embodiment to the user as search result markers. The search result markers that indicate how relevant said search results are for each of the search phrases.

In some cases, the search result markers are displayed as partly transparent so that the user can perceive plural search result markers even if partly or entirely overlaid.

In some cases, the user is provided with different suggestions for new search phrases. Such suggestions can be provided specifically to different points on the map. This can be performed, for example, on moving a cursor or hovering a touching object next to a touch display. The user may then select the suggestion for addition to the search phrases for a new search. The selecting can be conveniently arranged by detecting that the user touches the suggestion or points and clicks it with a pointing device such as a computer mouse, or presses a given key on a keyboard such as an “enter” key.

It is noticed that sometimes, the relevance comprises ambiguous areas. For example, in two-dimensional display, it may be difficult to clearly distinguish three dimensions. An embodiment comprises rearranging the relevance map to resolve ambiguity. For example, one or more of the search phrases can be temporarily disabled to permit a temporary focus on remaining search phrases. A disabled search phrase may be indicated by changing appearance of its indication in the relevance map. Moreover or alternatively, it is possible to change the orientation of dimensions of the relevance map presentation under user control. In an embodiment, the user control comprises dragging a search phrase indication that identifies an end of a respective dimension on the presentation of the relevance map for changing search phrase alignment. The search phrase indication may comprise a query marker. Still further, the method may comprise presenting two or more different instances of the relevance maps with different the alignment of the dimensions in which greatest distances between their dimension maxima (at respective query markers, for example) appear for different search phrases. The query marker may comprise any of a symbol; a search phrase as text; and an extract or abbreviation of the search phrase.

In an embodiment, the user is provided with an option to delete a search phrase. A desire of the user to delete a search phrase can be detected by prompting the user whether the search phrase should be deleted if the user points at the search phrase. In one case, the user is provided with an option to delete and with an option to disable a search phrase. This can be arranged, for example, by showing a pop-up menu on pointing at a query marker.

In an embodiment, the method comprises presenting a dynamic list of search results based on a position of interest indicated by the user on the relevance map. The position of interest can be indicated, for example, by hovering a touching object onto the position of interest or by moving an exploration cursor onto the position of interest. The search result markers that correspond to the search results being presented in the dynamic list can be highlighted in the relevance map to be user perceivably distinguishable from other search result markers. It is also possible to allow the user to scroll the dynamic list and optionally updating the highlighting of the search result markers that correspond to the search results being presented in the dynamic list so that the search result markers are highlighted for those search results that are visible in the scrolled dynamic list. Updating of the search results in the dynamic list and/or the relevance map can be performed additionally or alternatively on creation of a new search phrase and/or removal of an existing search phrase. Automatically performed arrangement of the relevance map may comprise displaying an updated set of search phrases. Further, once a search result has been made visible within the result list, its corresponding search result marker on the relevance map may be distinguished in a user perceivable appearance e.g. by using a distinguishing color. Alternatively or additionally, any other user perceivable appearance can be used.

In an embodiment, the method comprises visualizing search result markers that appear in the result list. For example, search result markers can be visualized with a user perceivable appearance in the coordinate map if they appear in the result list. The user perceivable appearance is provided, for example, by a particular color, highlight, box, pattern, blinking or other visual marking or effect.

Visited areas and non-visited areas of the relevance map may be visually distinguished. The visual distinguishing may employ a given user perceivable appearance in the coordinate map. The user perceivable appearance may be provided by a particular color, highlight, box, pattern, blinking or other visual marking or effect. For example, the relevance map may be explored through pointing at the map, which displays the search results around the pointed location. The visited areas on the relevance map may describe parts of the map that have been explored by pointing and re-ranking. or example, the visited areas on the relevance map may consist of all the search result markers whose corresponding data has been at some point visible in the result list.

The presenting of the search result markers can be further improved in some embodiments. For example, the user can be allowed to change the scale at which the relevance map is displayed. For example, the scale changing can be performed or controlled by the user by using a mouse scroll, or a pinch or zoom gesture on touch display, by tapping or double tapping a touch display and/or by a keyboard command. In a further example, once a search result has been made visible within the result list, its corresponding search result marker on the relevance map may become colored. Still further, the user can be allowed to distinguish between visited and non-visited areas of the relevance map according to use of indicative coloration of the search result markers. The search phrases can be displayed, for example, in a circular configuration.

The search phrases are input from the user with a text input box, for example. The text input can be displayed before performing a first search to receive the search phrase(s) for an initial search already. The input box is then preferably maintained visible for adding further search phrases. For example, on writing text to the input box and pressing enter or otherwise indicating that the input is ready (e.g., by waiting a moment or pointing outside the text box without deleting the text), a new search phrase can be added and the search be updated accordingly. The input box may be populated by the content of a search phrase on pointing a respective query marker. In this way, a search phrase can be easily added or changed based on an earlier search phrase. In one implementation, the user is allowed to drag the input box into the relevance map where it turns into a query marker at its destination. If that destination is on an existing query marker, then the new search phrase can replace the old one.

### DETAILED EXAMPLE

One example is next provided to illustrate some aspects and advantages of different embodiments and features that can be used. In this example, we present a relevance mapping and re-ranking technique that uses multi-dimensional ranking and two-dimensional interactive visualization. This example aims at providing a visual information retrieval system should support four main search phases, namely: (a) formulation of the search query; (b) actions to start the search; (c) review of the query results; (d) refinement of the search through successive queries or relevance feedback. For instance, informative feedback should be provided and consistency in the interface design should be maintained. Also, the user interface should be structured as an “information workspace” that reduces the cost of information processing for the accomplishment of specific tasks.

### Relevance Mapping

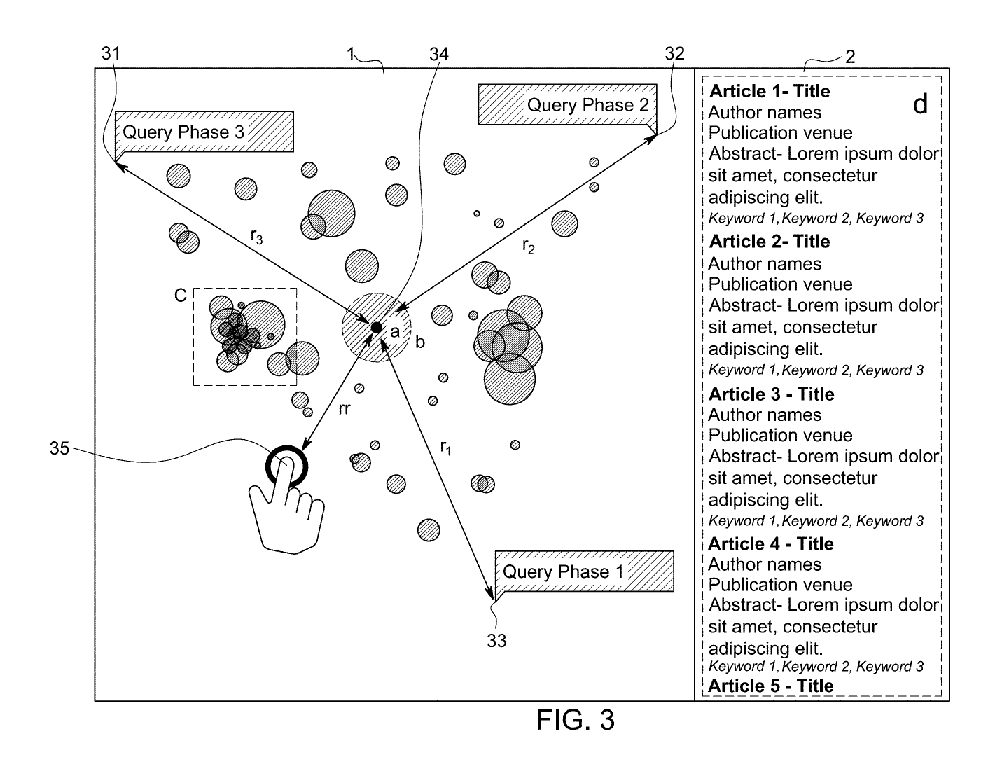

The present example meets the objectives or aims introduced in the foregoing and overcomes the problems of one-dimensional search result presentation, which is often implemented as a ranked list, by allowing the user to perceive the relevance distribution with respect to her query phrases by using a visualization that we call a relevance map. Relevance mapping allows the user to investigate specific areas on the map by re-ranking the results through pointing at the map. The method estimates document relevancies with respect to user specified query phrases in a multi-dimensional space in which the query phrases define the dimensionality. The method then computes a layout for the documents on a two-dimensional plane where the relevancies are relative distances from the query phrases, the radius defines the overall relevance of an individual document, and the opacity defines the document density at a certain point on the plane as shown in FIG. 3. The visualization allows the user to perceive how the result documents are distributed in the space with respect to both density and relevance to some query phrases.

It should be emphasized that the present document discloses various exemplary implementations without intention to restrict the applicability of the present document. For example, relevance mapping and relevance estimation and ranking are non-restricting examples on suitable computation methods. There are many other methods to rank, estimate relevance and compute layout.

FIG. 3 shows a view of an information retrieval user interface that is displayed to the user. The view of FIG. 3 has a first region 1 in which the relevance map is dynamically displayed and updated on changing the search phrases or the dimensions with which the relevance map is formed. FIG. 3 has also a second region 2 for a dynamic list of search results. Moreover, FIG. 3 shows three query phrase markers that indicate query markers 31 to 33 indicating the different dimensions corresponding to respective search phrases. Current exploration cursor 34 is shown. Initially, this cursor can be drawn in the center of the exploration map. FIG. 3 further shows how the exploration cursor 34 can be moved by dragging, for example, to a new point 35 chosen by the user.

Rather than relying only on a one-dimensional ranking algorithm to select the documents most relevant to a query, the role of the system is to organize and present information about many documents and multi-dimensional query phrases in a way that makes comparison possible. Re-ranking by pointing allows users to rank documents with respect to relative relevance weights to the query phrases. For example, expressing that a user wants the ranking to be based a little on both query phrases interaction and interfaces, but mainly on the phrase design can be done simply by pointing to an area on the map that is inside a triangle of the query phrases but closer to the concept design.

The approach was evaluated in a controlled laboratory study with 12 participants performing two tasks: perception and retrieval. In the perception task, participants were asked to find out how a document space was populated and organized with respect to specific topics, such as whether there was more research about interaction or design. In the retrieval task, the participants were asked to find documents with varying relevance to several topics, such as a document that was mainly related to design, but slightly related to interaction and interfaces.

Our results show that our method yields over 70% mean improvement in efficiency as measured in task execution time without compromising effectiveness measured as the quality of the task outcome. The results are consistent in both tasks. The results suggest that multi-dimensional ranking and visualization are effective for search result organization and re-ranking in cases when the initial one-dimensional result list is not enough for the user to analyze the information.

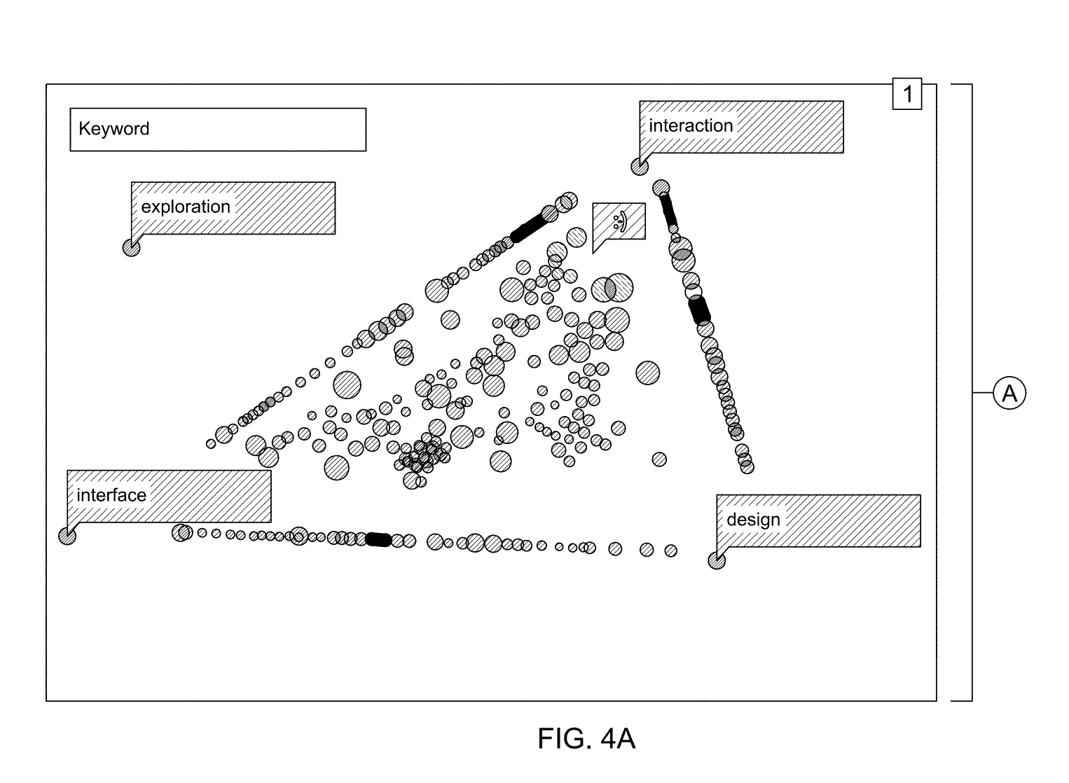

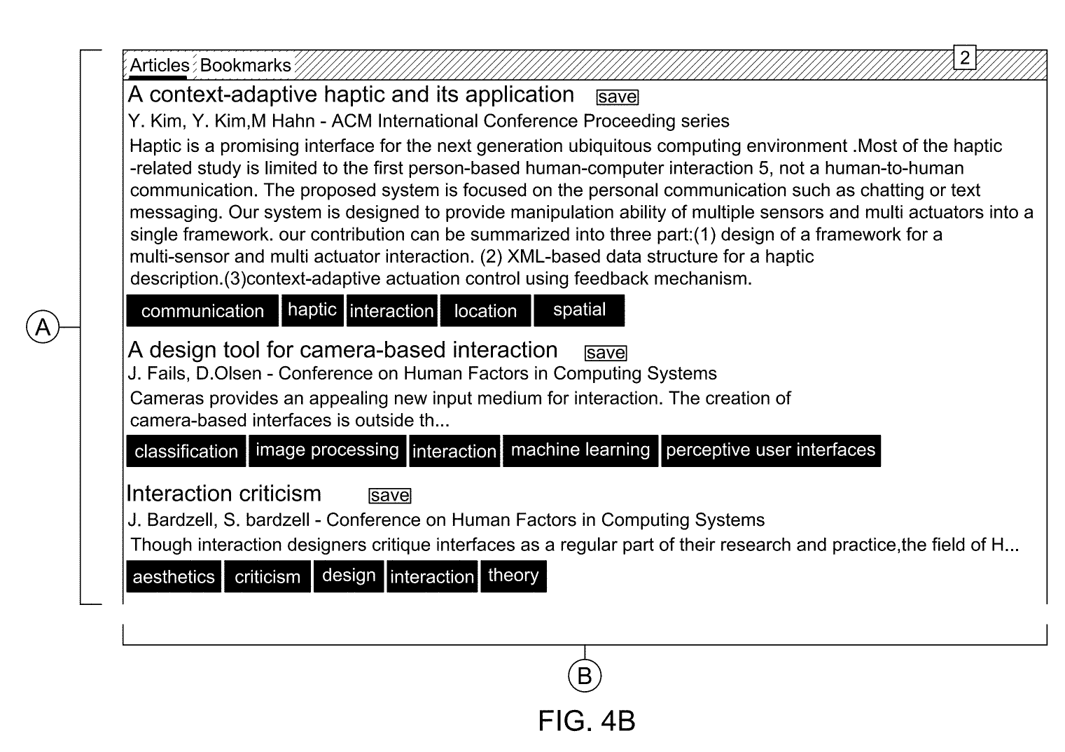

FIGS. 4A to 4C show further details of the relevance map. Here, a user investigates a document space delimited by three query phrases with corresponding query markers on the map:

### Design, Interaction and Interface.

A fourth query marker, exploration, is greyed out because it has been disabled to permit a temporary focus on the three remaining query markers. The user has positioned pointer or exploration cursor (here, a flag with a smiley face) close to one query marker (interaction) to investigate a collection of documents highly related to respective search phrase (interaction) and more loosely related to other search phrases the query markers of which are more distant to the exploration cursor (i.e., interface and design). As a result, a (dynamic) list 2 is provided to show search results or articles ranked with a specific focus on the selected area.

The user may temporarily disable a search phrase marker so as to temporarily reduce dimensions of the visualization of the relevance map. The relevance map need not be updated on disabling a search phrase marker. Instead, visualization of the relevance map can be changed so that the user can adjust weights of the presented search phrases that are not disabled. On the other hand, the user may also delete a query marker and corresponding search phrase (e.g. by dragging out of a visualization area) in which case the relevance map is updated accordingly. In one embodiment, the relevance map is displayed again using only the search phrases that are not disabled. The disabled search phrases may be displayed so that the user can enable them again by, for example, touching or clicking them.

Query markers are created by inputting keywords in the query box in the top left. Each query marker can be activated or disabled by clicking it. Documents returned by the system are visualized on the map as semi-opaque dots scattered between the query markers with respect to their individual relevance. The overall relevance of a document is indicated by the radius of the dot. The partial opacity translates overlapping into a darkened tint that cues the user on the number of document markers (or search result marker) in any given area. Query markers can be moved/dragged around on the map, which updates the position of the document markers. The position of the pointer can be positioned by dragging or tapping on the map. Any change in the pointer position or query marker organization triggers a re-ranking of documents based on their overall relevance and proximity to the pointer.

The ranked articles appear in a conventional one-dimensional list layout in the result list or the dynamic list 2. Documents being displayed in the result list are shown as red dots on the map. The result list is scrollable. In this case, the result list can be longer than its display area can show and only a subset of the result list is displayed at a time. Each document is displayed with its title, authors, publication venue, abstract and keywords. Abstracts are first shown partially but can be displayed in full at a click or a tap. Keywords are interactive, as they can be added to the map as new query markers by a click or tap.

### Layout

The data used to compute the relevance map layout consists of a set of m query phrases q_{1 . . . m} ∈Q, a set of k documents d_{1 . . . k}∈D and relevance estimates r_{1 . . . k}∈R for each of the k documents according to each of the m query phrases.

Each query marker and each document marker has a position on the plane, pos_{qx}, pos_{qy} and pos_{dx}, pos_{dy} respectively. The position of each query phrase marker is defined by the user by moving it to the desired position on the plane. The position of each of the document markers is computed as a weighted linear combination of the relevance scores to each query phrase and the relative position of the query marker. Intuitively, document markers are positioned proportional to their relevance to each of the query phrases. Formally, the position of a jth document marker on dimension dim is:

$${pos}_{{d}_{{i}_{dim}}} = \frac{{Σ}_{i}^{\vert Q \vert} {r}_{{q}_{i} {d}_{j}} \cdot {pos}_{{q}_{dim}}}{\vert Q \vert} \qquad ( 1 )$$

so that pos_{di}_{_{dim}}, is the coordinate of document dᵢ with respect to dimension dim. On a two-dimensional plane dim can be x or y. The relevance estimation r_{g}_{ᵢ}_{d}_{ⱼ} of a document to a query phrase is explained in the next section.

### Document Marker Visualization

The radius of the document marker is directly the relevance r_{q}_{ᵢ}_{d}_{ⱼ}. That is, the size of the dot is defined by the relevance.

The opacity of overlapping document markers is used to visualize the density of the document mass in a particular position on the plane. We use a standard computation of opacity in which opacity of o of a pixel on the plane is computed as:

o=1−(1−f)′ (2)

where n is the number of overlapping layers and f is a constant setting of an opacity effect of an individual layer and
was set to 1=0.95.

### Relevance Estimation and Ranking

The relevance estimation used in ranking and computing the document marker layout and size are explained in this section.

### Relevance Estimation

Given the document collection and a set of query phrases that specify the multiple dimensions to be used in ranking and visualization, the relevance estimation method results in a set of probabilities r_{1 . . . k}∈R for each document d of k documents in the collection according to each query phrase q_{1 . . . m}∈Q.

To estimate the probabilities from the query phrases Q and documents D, we utilize the language modeling approach of information retrieval.

We use a multinomial unigram language model. The vector Q of query phrases is treated as a sample of a desired document, and document dⱼ is ranked according to a query phrase qᵢ by the probability that qᵢ would be generated by the respective language model M_{d}_{ⱼ} for the document; with the maximum likelihood estimation we get

$$P ( q \vert {M}_{{d}_{j}} ) = {\prod }_{i = 1}^{M} {{\hat{P}}_{mle} ( {q}_{i} \vert {M}_{{d}_{j}} )}^{{w}_{i}} , \qquad ( 3 )$$

where wᵢ is the weight of each of the query phrases and is set as

$${w}_{i} = \frac{1}{\vert Q \vert}$$

as default. In case of interactive re-ranking wᵢ is weighted based on user interactions as explained in the next section.

To estimate the relevance r_{q}_{ᵢ}_{d}_{ⱼ} of an individual document dⱼ with respect to an individual dimension defined by each query phrase qᵢ and avoid zero probabilities, we then compute a smoothed relevance estimate by using Bayesian Dirichlet smoothing for the language model so that

$${r}_{{q}_{{i}_{{d}_{i}}}} = {P}_{mle} ( {q}_{i} \vert {M}_{{d}_{j}} ) = \frac{c ( {q}_{i} \vert {d}_{j} ) + μ p ( {q}_{i} \vert C )}{{Σ}_{k} c ( q \vert {d}_{j} ) + μ} , \qquad ( 4 )$$

where c(dᵢ|dⱼ) is the count of a query phrase qᵢ in document dⱼ, p(qᵢ|C) is the occurrence probability (proportion) of a query phrase qᵢ in the whole document collection, and the parameter μ is set to 2000.

### Ranking

Given the probability estimates for each of the documents, we apply a probability ranking principle to rank the documents in descending order of their probabilities for the query phrases. These are then used to compute the total ordering of the document list.

The user can interactively re-rank the result list by selecting a point on the relevance map. The point for the desired re-ranking is defined by its two-dimensional coordinates rrₓ and rr_{y} with respect to the two-dimensional coordinates of the query markers pos_{qi}_{ₓ} and pos_{qi}_{_{y}} for the i=1 . . . |Q| query phrases.

The re-rank weighting for an ith query marker is computed as the Euclidean distance between the pos_{q}_{ᵢₓ} and pos_{q}_{_{iy}} and the rrₓ and rr_{y}. Formally,

$${w}_{i} = \frac{\sqrt{{( {pos}_{{q}_{{i}_{x}}} - {rr}_{x} )}^{2} + {( {pos}_{{q}_{{i}_{x}}} - {rr}_{y} )}^{2}}}{{Σ}_{i}^{\vert Q \vert} {q}_{i}} , \qquad ( 5 )$$

The re-ranking of the documents is then computed using these distances by Formula 3 by setting the weight wᵢ accordingly. Intuitively, the distance from the query marker is used as the importance of the query phrase in the ranking of the documents.

### EXPERIMENTS

We conducted a controlled laboratory experiment in which the relevance mapping and re-ranking were compared to a conventional ranked list visualization in two tasks: perception and retrieval.

### Hypotheses

The study tested the following four hypotheses:
H1: Efficient perception hypothesis: The relevance map is more efficient and allows faster perception than a ranked list.
H2: Efficient retrieval hypothesis: The relevance map is more efficient and allows faster retrieval than a ranked list.
H3: Effective perception hypothesis: The relevance map is more effective and allows more accurate perception than a ranked list.
H4: Effective retrieval hypothesis: The relevance map is more effective and allows more accurate retrieval than a ranked list.

### Experimental Design

The experiment used a 2×2 within-subjects design with two search tasks and two systems. The conditions were counterbalanced by varying the order of the systems and tasks.

### Baseline

A baseline system was implemented to enable comparability and as to ensure that the evaluation revealed the effects solely on the features enabling relevance mapping and re-ranking. The baseline used the same data collection as well as the same document ranking model. All retrieved information in the baseline system was displayed with a ranked list layout. The baseline did not feature a relevance map, and the ranking was based on a single query at a time. The baseline was using the same hardware, i.e., a multitouch-enabled desktop computer with a physical keyboard.

### Tasks

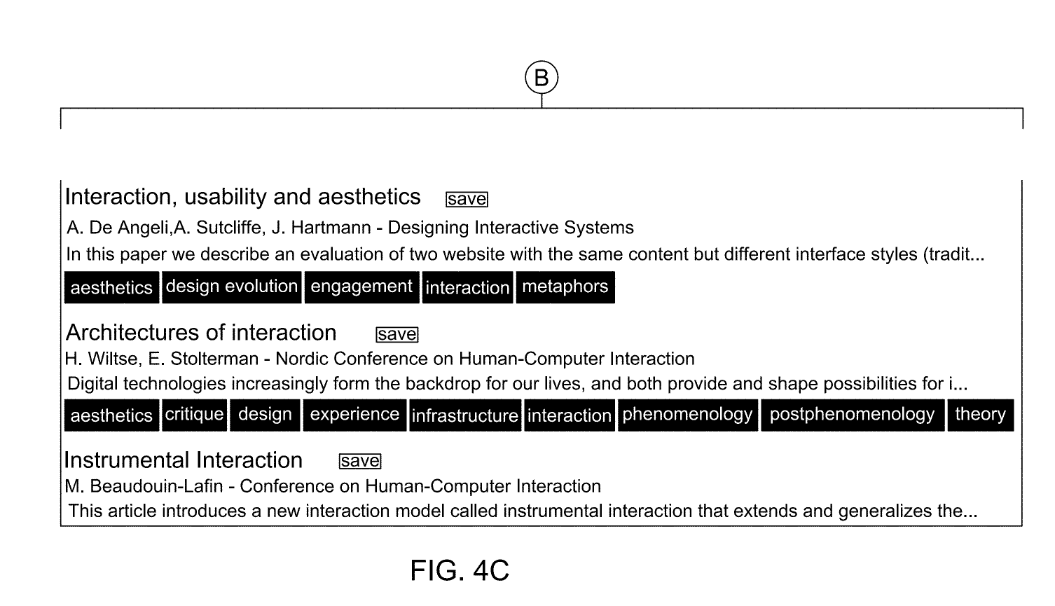

The experiment consisted of two tasks, perception and retrieval, which are explained below and exemplified in FIGS. 6, 7, and 8. Both tasks used a common set of four topics, either (1.) interaction, tabletop, tangible, and prototyping, or (2.) surfaces, exploration, visualization, and sound. The two set of topics were formed by two researchers who were experts on human-computer interaction. The same researchers were then asked to assess the task outcomes of the participants.

### Perception Task

The perception task was designed to assess efficiency and effectiveness in helping to understand how a document space is populated and organized with respect to specific query topics. Participants were asked the following two questions: (1.) “Out of the 4 topics provided, which 2 topics are related to the highest amount of relevant documents?”, and (2.) “Out of the 4 topics provided, which 3 topics are related to the highest number of relevant documents?”.

An example visualization from which the user had to select the topics is shown in FIG. 6.

### Retrieval Task

The retrieval task was designed to assess efficiency and effectiveness in finding documents with varying multidimensional relevance toward several topics. Participants were given the following instruction: “Find one article that is highly relevant to Topic A and slightly related to Topic B and Topic C.”. The task was then repeated one more time with a different topic priority: “Find one paper that is highly relevant to Topic B and slightly related to Topic A and Topic C.”

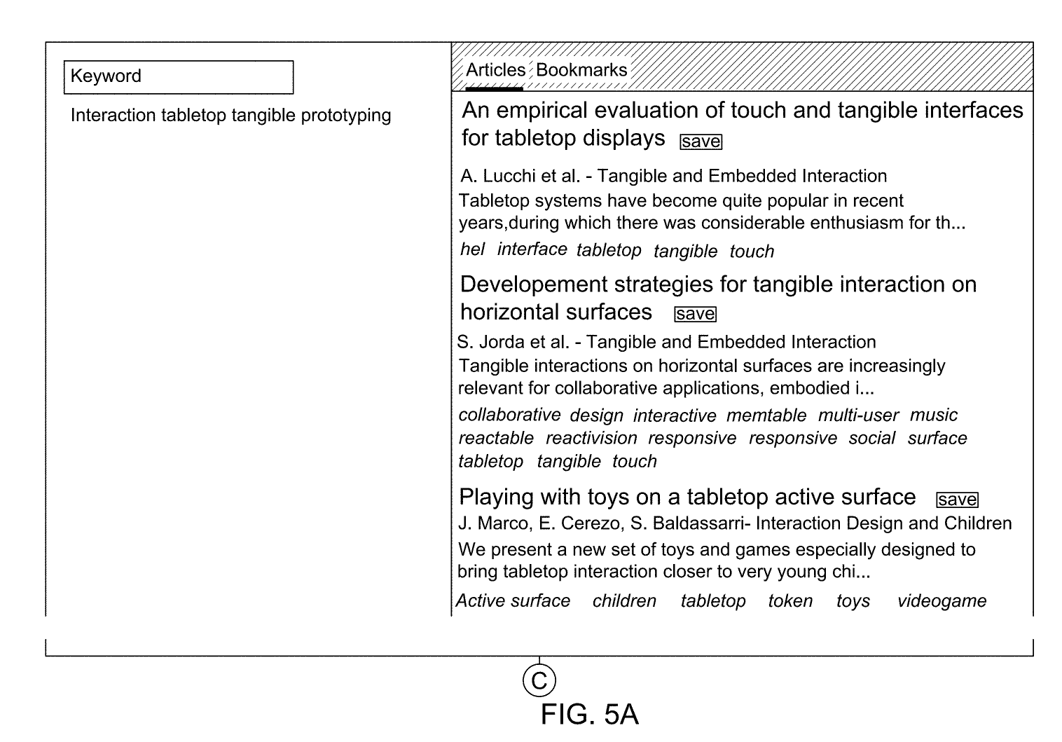

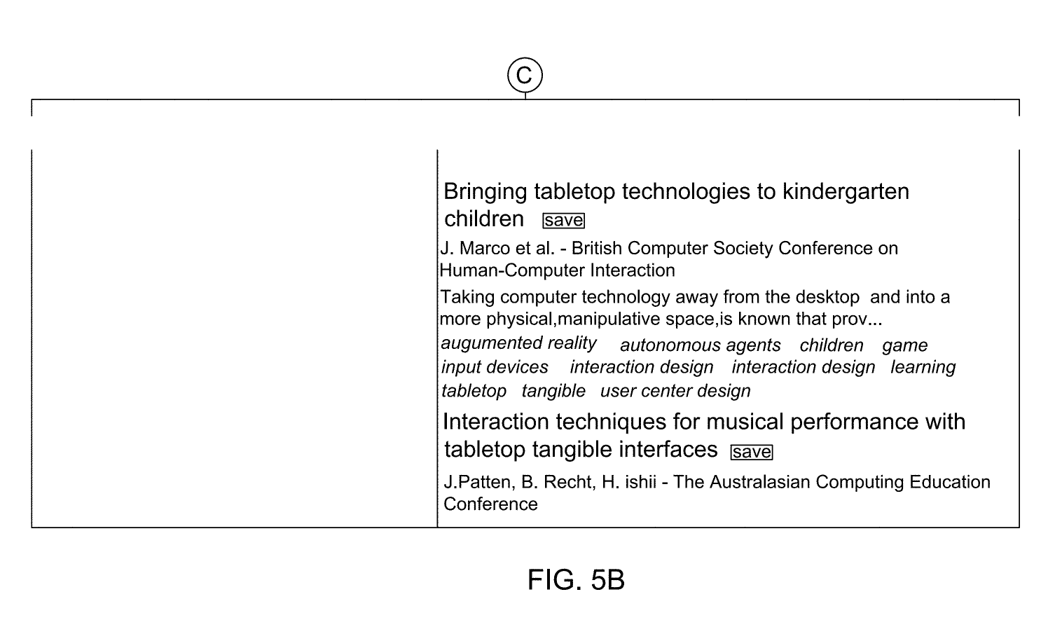

An example sequence of a visualization, user pointing to the visualization to re-rank the document list from which the user had to select the documents is shown in FIGS. 7 and 8.

### Measures

We used two performance measures, efficiency and effectiveness, and one descriptive measure, interaction behavior. Efficiency measured the time required to complete the task. Effectiveness measured the quality of the task outcome. Interaction behavior measured parameters related to user behavior.

### Efficiency

Efficiency was computed directly as the duration in seconds from the beginning of the task to the completion of the task.

### Effectiveness

Effectiveness was computed differently for the two tasks and the corresponding ground truths for the task outcomes were defined differently.

In the perception task, the ability of the user to perceive which parts of the document space were more densely populated with relevant documents was measured. The ground truth was available from the relevance estimation and was computed as a sum of the relevancies associated to each query phrase representing the topic. The query phrases were then ordered based on the sum of relevancies and the top 2 and top 3 corresponding to the task description were selected as the ground truth query phrases corresponding to the topics. The effectiveness was then measured as the ratio of the topics reported by the user with respect to the ground truth query phrases.

In the retrieval task, the ability of the user to find documents that were highly relevant to one topic and slightly relevant to other topics was measured.

The documents chosen by any of the participants in any of the two system conditions were pooled. Two experts then assessed the relevance of each document to each query phrase that was visible on the screen in a double-blind setting. In other words, the experts graded relevance of the articles with respect to the topics, but they did not know which of the topics had been previously defined as highly relevant, which were the slightly related topics, and which were non-related topics.

The experts assigned a grade between 0 (non-relevant) and 5 (highly relevant) to each of the topics for each document. After the grading, the grade for the topic that was defined highly relevant in the task was multiplied by two, and the final relevance grade for each document was then computed as the mean of the grades for the relevant topics divided by the maximum possible grade. Intuitively, the relevance of each document was graded with respect to each topic; the highly relevant topic was considered twice as important as the slightly relevant topics, and non-relevant topics did not contribute to the total relevance score. The total relevance score for a set of topics that were defined in the tasks was then computed and it indicated the expert opinion on how relevant the document was for the task.

The inter-annotator agreement between the experts was measured by using Cohen's Kappa for two raters who provided three relevance assessments per document. Agreement was found to be substantial (Kappa=0.637, Z=5.61, p<0.001), indicating that the expert assessments were consistent.

### Interaction Behavior

Interaction behavior was measured solely in the retrieval task as the perception task did not require active interaction behavior from the participants. Two measures were computed. First, the position in the result list of the article chosen by the participant. Second, the total number of interactions performed during the task.

Intuitively, more interactions and lower position would indicate a preference to re-rank to improve ranking for faster access to relevant information, while less interactions and higher position would indicate relying in the result listing as the main source of information.

### Dataset

We used a document set including all articles available at the Digital Library of the Association of Computing Machinery (ACM) as of the end of 2011. The information about each document consists of its title, abstract, author names, publication year, and publication venue. Articles with missing information in the metadata were excluded during the indexing phase, resulting in a database with over 320,000 documents. Both the baseline and the proposed system used the same document set and the users were presented with the top 2000 documents.

### Participants

Twelve researchers in computer science (five women, seven men) from two universities, ranging in age from 21 to 32 years old and from 1 to 11 years in research experience, volunteered to participate in the experiment. The participants were all compensated with a movie voucher that they received at the end of the experiment. All participants were assigned the same experimental tasks on both systems with systematic varying order between the systems. In this experiment, informed consent was obtained from all participants.

### Apparatus

Participants performed the experiment on a desktop computer with a 27″ multi-touch-enabled capacitive monitor (Dell XPS27). The computer was running Microsoft Windows 8 and both systems—being Web based—were used on a Chrome Web browser version 45.0.2454.85 m. A physical keyboard was provided for text input, whereas pointing, dragging and scrolling were performed through touch interaction. The search engine implementing the relevance estimation method was running on a virtual server and the document index was implemented as an in-memory inverted index allowing very fast response times with an average latency of less than one second.

### Procedure

The tasks were described on individual instruction sheets that incorporated one of the two sets of keywords, which we will refer as the task versions. The duration of the tasks was not constrained. To avoid introduction of confounding variables, we counterbalanced the tasks by systematically changing the order of the systems, the order of the task versions, and which task version was allocated to each system.

A training version of the tasks was given to each participant and had to be done using each system, right before the main task. The corresponding instruction sheet was an exact replica of the effective instruction sheet but made its training status explicit in the title. The training used a separate set of four keywords: creativity, collaboration, children and robotics.

The training started with the participant receiving a tutorial on how to use the system, then, while performing the training task, she could ask questions about either the task or the system. As soon as the training task was completed and the participant had no more questions, the experiment started to be completed without help.

The perception task was completed by underlining the chosen answers on the instruction sheet. In the retrieval task, we took advantage of the bookmarking feature of both systems and asked the participants to bookmark the chosen articles. A Start/Submit button was added to both systems in the upper right corner. To be able to use each system, participants had to tap Start when ready to perform each task and Submit when they had completed it.

For the purpose of the efficiency measurement, we recorded (1) the task duration from the start button press to the end button press. For the purpose of the effectiveness measurement, we recorded (2) bookmarked documents.

After completion of both tasks in both conditions, participants were given a questionnaire to collect data on their age, gender, academic background and research experience.

### Results

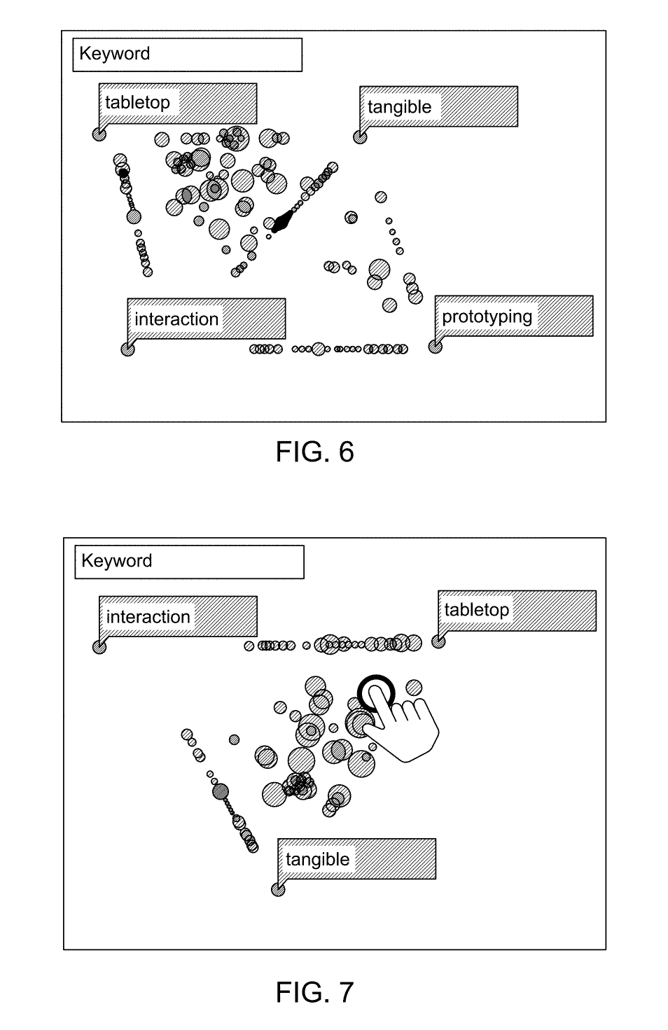

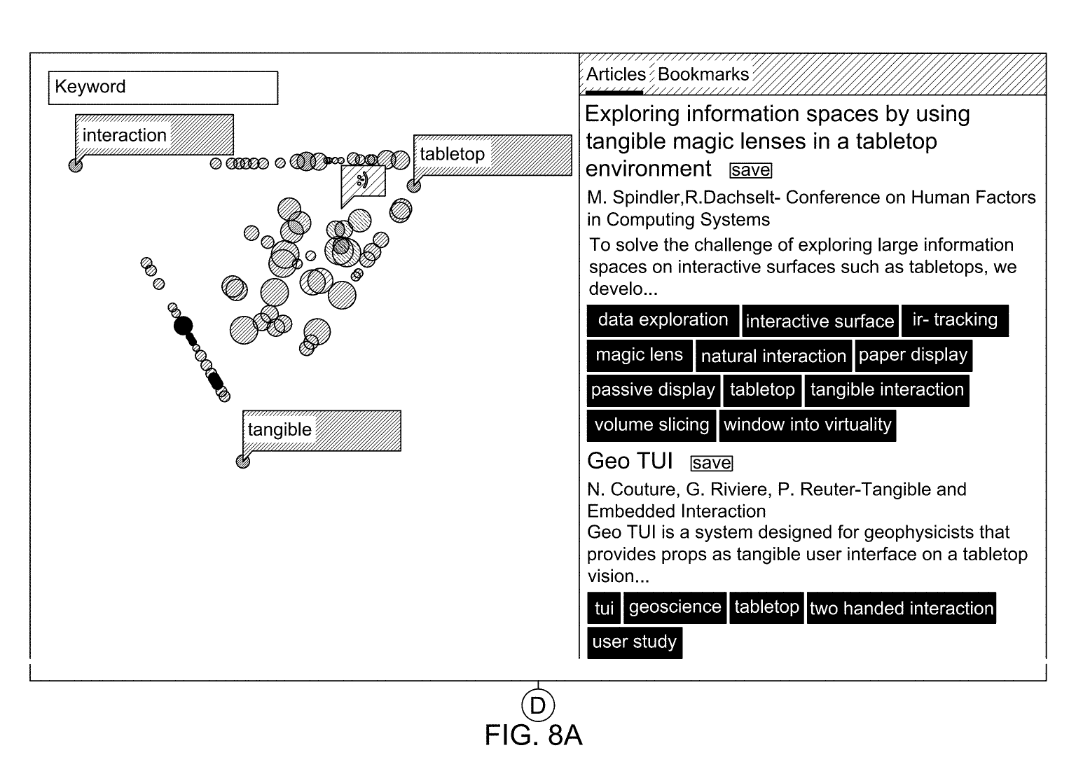

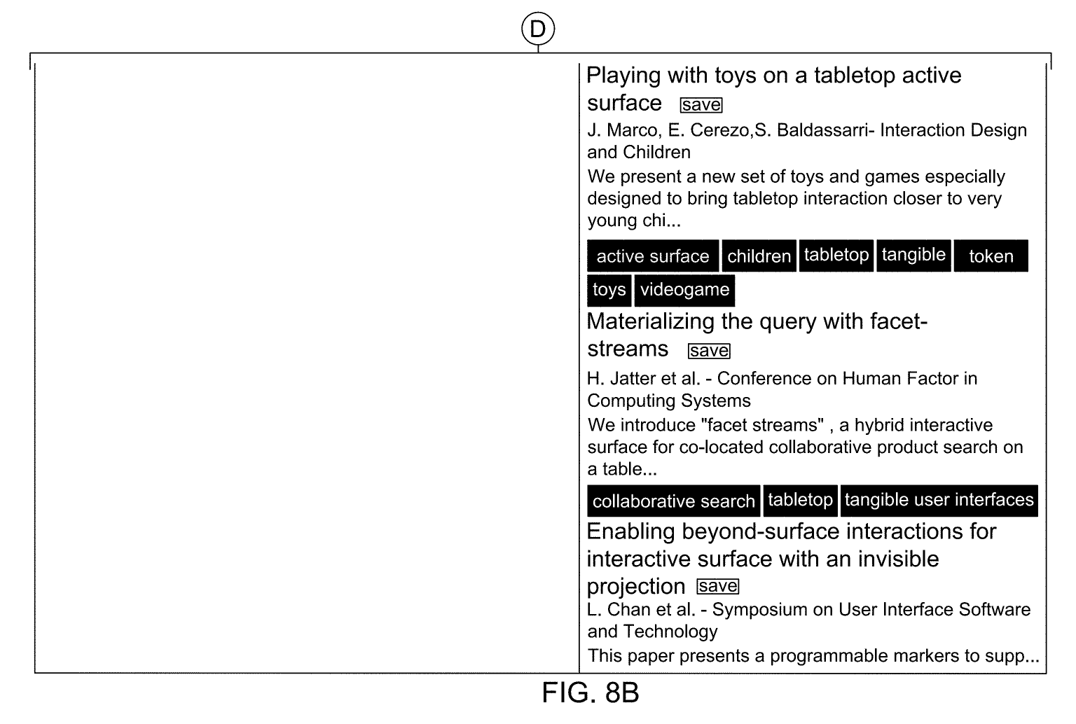

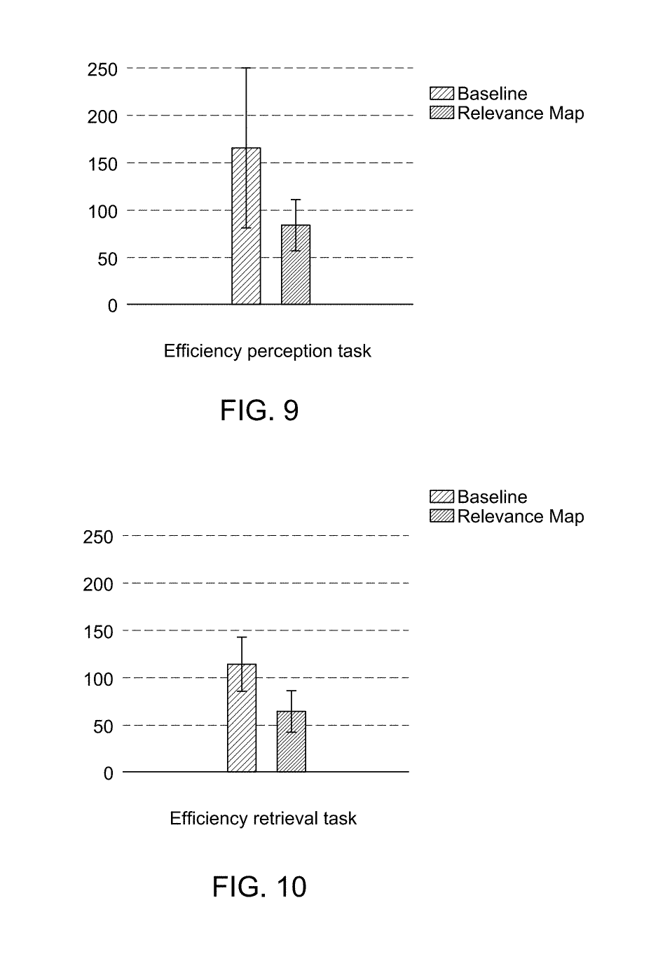

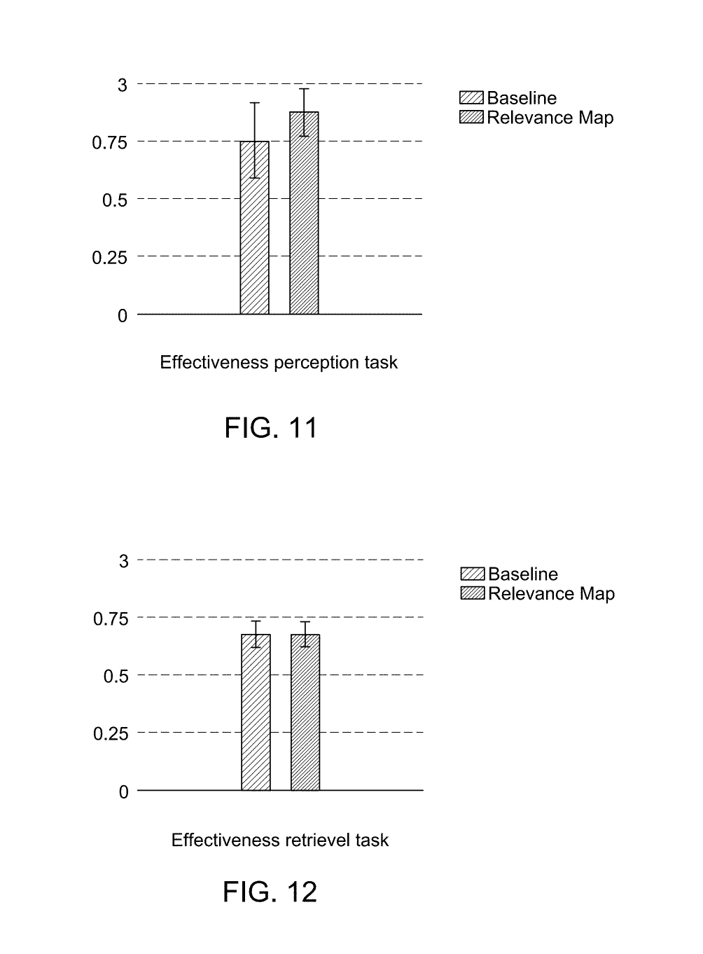

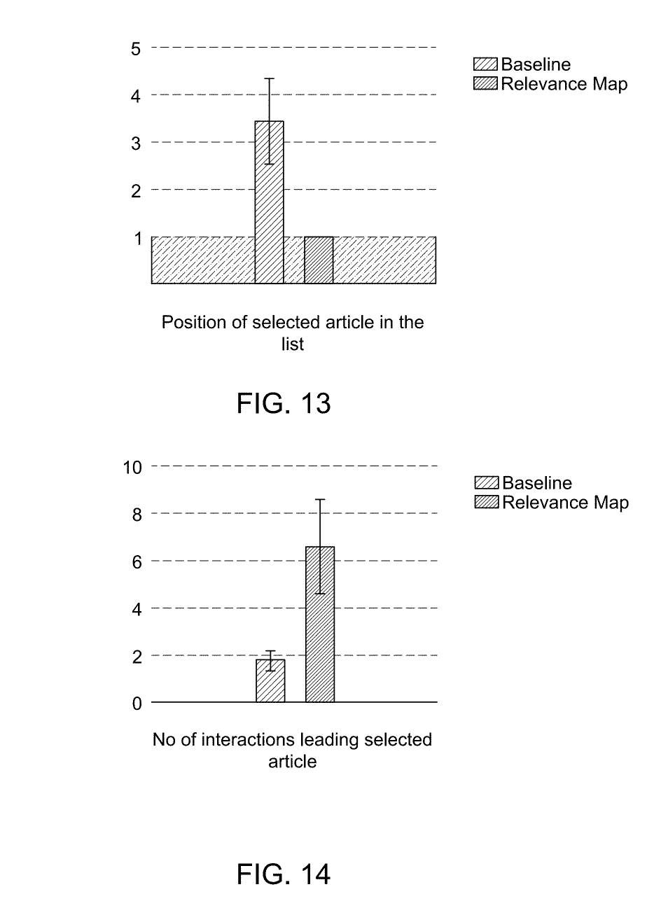

The results of the experiment regarding performance are shown in Table I and illustrated in FIGS. 9 to 12 with respect to the selected measures: efficiency and effectiveness, and reported according to both tasks, perception and retrieval. The results regarding interaction behavior are shown in Table 2 and illustrated in FIGS. 13 and 14 with respect to selected parameters: position of the selected article in the result list, and number of interactions during the search task. The results are discussed in detail in the following sections.

TABLE I
Efficiency and effectiveness results for both tasks. Efficiency is
reported as a duration of the task averaged over participants. Effectiveness
in the perception task is reported by mean quality of topics averaged
over participants, and effectiveness in the retrieval task by mean quality
of documents averaged over participants. Results showing significant
improvement over the baseline are shown in bold.

| Baseline | | Map | | Baseline vs. Map |
|---|---|---|---|---|
| M | SD | M | SD | Wilcoxon Test |

Efficiency

| | | | | | |
|---|---|---|---|---|---|
| Perception | 166.23 | 138.85 | 86.97 | 48.08 | Z = 2.08 (p = 0.04) |
| Retrieval | 117.16 | 70.32 | 65.57 | 56.55 | Z = 3.03 (p = 0.001) |

Effectiveness

| | | | | | |
|---|---|---|---|---|---|
| Perception | 0.75 | 0.26 | 0.87 | 0.17 | Z = −1.83 (p = 0.07) |
| Retrieval | 0.67 | 0.15 | 0.68 | 0.13 | Z = 0.06 (p = 0.96) |

TABLE II
Interaction behavior measured in the retrieval task. Position of
selected article is reported by mean position in the result list
of each selected article averaged over participants. Number
of interactions is reported by mean number of interactions
performed during the task, averaged over participants.
Interaction behavior

| | Baseline | | Map | | Baseline vs. Map |
|---|---|---|---|---|---|
| | M | SD | M | SD | Wilcoxon Test |
| Position of | 3.45 | 2.20 | 1.00 | 0.00 | Z = 3.94 (p < 0.001) |
| selected article | | | | | |
| Number of | 1.83 | 1.13 | 6.62 | 4.80 | Z = −3.98 (p < 0.001) |
| interactions | | | | | |

### Efficiency

Efficiency was measured as the time required to complete the task. Significant differences were found between the systems in terms of efficiency in both tasks, which are discussed as follows.

### Perception Task

The results of the perception task show that participants spent substantially less time completing the perception task when using the relevance map than when using the baseline system. The mean task duration for the relevance map was 86.97 seconds, while the mean task duration for the baseline system was 166.23 seconds. The differences between the systems were found statistically significant (Wilcoxon pair-matching ranked-sign test: Z=2.08; p=0.04). In conclusion, the relevance map shows 91% improvement, and was therefore more effective for the perception task, confirming H1.

### Retrieval Task

In the retrieval task, participants spent substantially less time completing the task when using the relevance map than when using the baseline system. The mean task duration for the relevance map was 65.57 seconds, while the mean task duration for the baseline system was 117.16 seconds. The differences between the systems were found to be statistically significant (Wilcoxon pair-matching ranked-sign test: Z=3.03; p=0.001). In conclusion, relevance map shows 79% improvement and was therefore more effective for the retrieval task, confirming H2.

### Effectiveness

### Perception Task

In the perception task, the effectiveness as measured by the mean quality of the topics selected by the participants with the relevance map is 0.87, while the mean quality of topics for the baseline system is 0.75. The differences between the systems were not found statistically significant (Wilcoxon pairmatching ranked-sign test: Z=″1.83; p=0.07) and do not allow to confirm H2.

### Retrieval Task

No statistically significant difference in the relevance of retrieved documents was found in the retrieval task (Wilcoxon pair-matching ranked-sign test: Z=0.06 and p=0.96). The chart of FIG. 9 shows very similar results for both systems. This result fails to confirm H4, but it shows that the improvement in efficiency observed in the retrieval task did not impair the quality of the retrieved documents.

### Interaction Behavior

Interaction behavior was measured as the position of the selected article in the result list and the number of interactions used during the task.

### Position of Selected Article

Using the relevance map, participants selected exclusively top articles in the result list, while the mean position of the selected article for the baseline system was 3.45. The differences between the systems were found statistically significant (Wilcoxon pair-matching ranked-sign test: Z=3.94; p<0.001).

### Number of Interactions

Participants performed substantially more interactions to select an article during the retrieval task when using the relevance map than when using the baseline system. The mean number of interactions for the relevance map was 6.62, while the mean number of interactions for the baseline system was 1.83. The differences between the systems were found statistically significant (Wilcoxon pair-matching ranked-sign test: Z=″3.98; p<0.001).

### DISCUSSION

The results of the experiments show significant improvements in efficiency in both tasks: perception and retrieval, without compromising effectiveness. These results confirmed hypotheses H1 and H2. Relevance mapping is more efficient than a ranked list in both perception and retrieval.

In the perception task, participants were able to use the relevance map visualization to make decisions with equal quality of the task outcome in almost half of the time (91% faster). In the retrieval task, documents fitting complex criteria were retrieved 79% faster using re-ranking through interaction with the relevance map. While finding documents with different relevance to several topics requires users to go through long lists of results and assess the relevance of individual documents, our proposed method for re-ranking through pointing at the map successfully narrows down the top results to documents that fit the criteria.

Our results show equal effectiveness. The quality of the task outcome was the same in both conditions and tasks. These results failed to confirm hypotheses H3 and H4. A possible reason for equal performance is the absence of strict time constraints for participants to complete the tasks. It is possible that more constrained time to complete the task would have negatively impacted the quality of the task outcome for the baseline, as it would not have been possible for the participants to carefully examine the list to find a fitting article but would have forced the participants to skim, therefore resulting in possibly lower quality of selected topics and articles.

While our results show substantial improvements over the baseline (70%-91%), our results are limited to more complex tasks in which users are seeking insights from the data, rather than performing simple look-up retrieval tasks. Simpler interfaces and interaction techniques may be well suited for simpler tasks in which comparison and investigation of result space is not important and users can rely solely on search engine ranking.

### CONCLUSION

The method proved successful in substantially improving performance over complex analytical tasks. Evaluation showed that users are able to make sense of the relevance map and take advantage of the re-ranking interaction to dramatically lower the time required to make analytic decisions or retrieve documents based on complex criteria.

Various embodiments have been presented. It should be appreciated that in this document, words comprise, include and contain are each used as open-ended expressions with no intended exclusivity.

The foregoing description has provided by way of non-limiting examples of particular implementations and embodiments of the present disclosure a full and informative description of the best mode presently contemplated by the inventors for carrying out the present disclosure. It is however clear to a person skilled in the art that the present disclosure is not restricted to details of the embodiments presented in the foregoing, but that it can be implemented in other embodiments using equivalent means or in different combinations of embodiments without deviating from the characteristics of the present disclosure.

The disclosed embodiments provide numerous technical advantages and advances in accelerating and enhancing performance of information retrieval tasks. Notably, the organizing of data and arranging its presentation is far beyond mere presentation of information or man-made methods. The present embodiments provide techniques for controlling information retrieval process that is impossible to perform by pen and paper, for example. For example, on adjusting the dimensions or search phrases of the relevance map, the map should be dynamically and automatically adapted to reflect the change without excessive delays (e.g. within one second, two seconds or five seconds, for example). It would be impossible to calculate rankings for plural documents and calculate where their markers should be placed on the relevance map without automatic data processing. The embodiments also provide clear and tangible concrete advantages in that finding desired information is accelerated and thereby the user interface operation is enhanced and the tasks are completed faster. In effect, some embodiments provide an enhanced man-machine interface with which information can be presented and searching process can be directed literally with an added dimension over prior known use of search result lists.

Furthermore, some of the features of the afore-disclosed embodiments of this present disclosure may be used to advantage without the corresponding use of other features. As such, the foregoing description shall be considered as merely illustrative of the principles of the present disclosure, and not in limitation thereof. Hence, the scope of the present disclosure is only restricted by the appended patent claims.

1. A method, comprising:
a) organizing multi-dimensionally a plurality of search results obtained with a plurality of search phrases;
b) presenting to a user the plurality of search phrases multi-dimensionally in a relevance map, each search phrase corresponding to one dimension of the relevance map;
c) identifying a point on the relevance map that is pointed by the user;
d) defining weights of the search phrases according to the point on the relevance map;
e) ranking documents based on the weights and based on the ranking forming a result list that identifies a plurality of the documents as search results;
f) presenting the result list; and
g) returning to step c).

2. The method of claim 1, comprising receiving the search phrases from the user.

3. The method of claim 1, wherein the search results are presented to the user as search result markers that indicate that how relevant said search results are for each of the search phrases.

4. The method of claim 3, wherein that the presenting of the search result markers may comprise indicating total relevancies of respective search results with respect to all the search phrases.

5. The method of claim 1, comprising temporarily disabling one or more of the search phrase markers and rearranging search result markers accordingly so as to permit a temporary focus on remaining search phrases.

6. The method of claim 1, comprising changing the search phrases.

7. The method of claim 1, comprising automatically arranging the relevance map upon creation, changing or removing a search phrase.

8. The method of claim 7, wherein the automatic arrangement of the relevance map comprises displaying an updated set of search phrases.

9. The method of claim 1, comprising changing the orientation of dimensions of the relevance map presentation under user control.

10. The method of claim 1, comprising changing the scale of the relevance map presentation under user control.

11. The method of claim 10, wherein the changing of scale is performed using a mouse scroll or a pinch or zoom gesture on touch display.

12. The method of claim 1, comprising presenting a dynamic list of search results based on a position of interest indicated by the user on the relevance map.

13. The method of claim 1, wherein the search result markers that correspond to the search results being presented in the dynamic list are highlighted in the relevance map to be user perceivably distinguishable from other search result markers.

14. The method of claim 1, comprising visualizing the search result markers that appear in the result list.

15. The method of claim 1, wherein the search result markers are visualized with a user perceivable appearance in the coordinate map if they appear in the result list.

16. The method of claim 1, wherein visited areas and non-visited areas of the relevance map are visually distinguished.

17. The method of claim 1, wherein search phrases are shown in the relevance map presentation in a circular configuration.

18. A computer program stored in a non-transitory memory medium and comprising computer executable program code configured, when executed, to cause an apparatus to perform the method of claim 1.

19. An apparatus comprising:
a memory comprising a computer program of claim 18; and
a processor configured to perform the computer program code.
